(19) United States
(12) Patent Application Publication
(10) Pub. No.: US 2016/0239906 A1
(43) Pub. Date: Aug. 18, 2016

(54) SPECULATIVE ALLOCATION OF INSTANCES

(71) Applicant: EMPIRE TECHNOLOGY DEVELOPMENT LLC, Wilmington, DE (US)

(72) Inventor: Ezekiel Kruglick, Poway, CA (US)

(21) Appl. No.: 14/380,571

(22) PCT Filed: Aug. 27, 2013
(86) PCT No.: PCT/US13/56827

§ 371 Date: Aug. 22, 2014

(51) Int. Cl. G06Q 30/08; G06F 17/30; G06Q 30/02

(52) U.S. Cl. CPC G06Q 30/08; G06Q 30/0202; G06F 17/3053

(57) ABSTRACT

In one example embodiment, operations may include predicting winning bidders in an auction for computing resources; pre-placing machine images before the auction has been completed; booting-up at least a portion of the pre-placed machine images before the auction has been completed; and assigning a booted-up virtual machine to one of the predicted auction winners.

### TECHNICAL FIELD

The embodiments described herein pertain generally to speculative allocation of resources in a datacenter environment.

### BACKGROUND

Unless otherwise indicated herein, the approaches described in this section are not prior art to the claims in this application and are not admitted to be prior art by inclusion in this section.

Real-time pricing and trading of datacenter resources provide efficient usage of resources and capital opportunity for datacenter owners. However, as users attempt to arbitrage smaller time periods, delays in readying resources for use result in lost resources for datacenter owners and auction participants. That is, auction time may waste resources.

### SUMMARY

In one example embodiment, a method for speculative allocation of computing resources may include: tracking data, for each of one or more users of computing resources, including a respective history of auction bids and a respective history of computing resource usage; predicting, based on the tracked data, respective probabilities that each of the one or more users will submit a qualifying bid for one or more available computing resources during a current auction; ranking the predictions; and preparing the available computing resources for allocation to at least one of the users in accordance with the ranked predictions.

In another example embodiment, a system for speculative allocation of computing resources may include: a management module configured to store prediction variables; a prediction module configured to predict, based on at least the prediction variables, respective probabilities that one or more users will submit a qualifying bid for one or more available computing resources during a current auction; a hypervisor configured to prepare the available computing resources for allocation upon completion of the current auction.

In yet another example embodiment, a computer-readable medium may store executable-instructions that, when executed, cause one or more processors to perform operations including: predicting winning bidders in an auction for computing resources; pre-placing machine images before the auction has been completed; booting-up at least a portion of the pre-placed machine images before the auction has been completed; and assigning a booted-up virtual machine to one of the predicted winning bidders who has submitted a winning bid.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example datacenter system configuration in which speculative allocation of instances may be implemented, arranged in accordance with at least some embodiments described herein;

FIG. 2 shows an example processing flow of operations to implement speculative allocation of instances, arranged in accordance with at least some embodiments described herein;

FIG. 3 shows an example processing flow of operations to implement resource preparation for allocation, arranged in accordance with at least some embodiments described herein; and

FIG. 4 shows a block diagram illustrating an example computing device by which various example solutions described herein may be implemented, arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

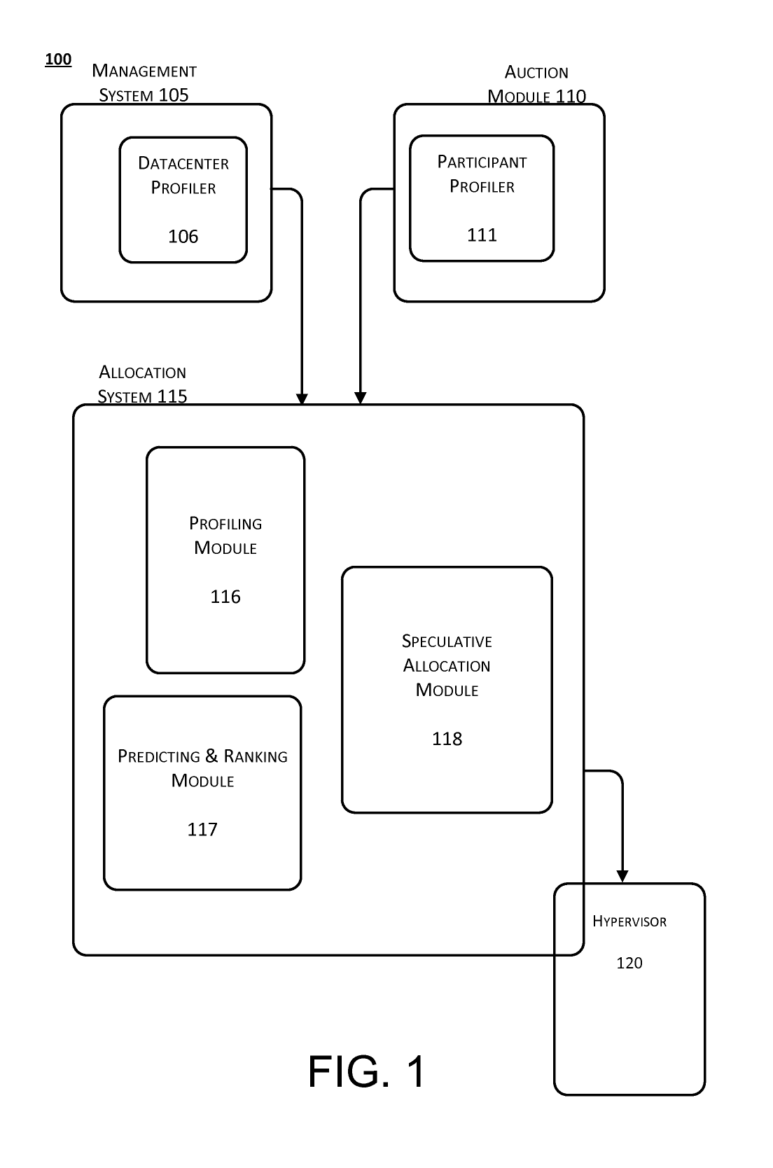

FIG. 1 shows an example datacenter system configuration 100 in which speculative allocation of instances may be implemented, arranged in accordance with at least some embodiments described herein. As depicted, datacenter system configuration 100 includes, at least, a management system 105; an auction module 110, an allocation system 115, and a hypervisor 120. As further depicted, management system 105 may include a datacenter profiler 106; auction module 110 may include a participant profiler 111; and allocation system 115 may include a profiling module 116, a predicting and ranking module 117, and a speculative allocation module 118.

Datacenter system configuration 100 may pertain to at least portions of a datacenter, or cloud services platform, of which computing resources may be rented, leased, or otherwise allocated on a non-permanent time- or task-basis. As referenced herein, unless otherwise indicated expressly, by example, or by context, computing resources may be understood to include but not be limited to one or more virtual machine instances, at least portions of field programmable gate arrays (FPGA), compute containers, network resources, software services etc. In the context of configuration 100, a user may be regarded as, at least, an auction participant who may at least be speculated to submit bids to rent, lease, or otherwise be allocated one or more computing resources in accordance with various business models that include, but are not limited to, auctions. Thus, a user and auction participant may be interchangeably referenced herein. With regard to the auction business model, a user may be allocated one or more computing resources, e.g., by the minute, hour, day, week, etc., or as a task-based rental.

In accordance with one or more example embodiments, consumers may rent, lease, or otherwise be allocated one or more virtual machine instances hosted by such a datacenter to run one or more personal applications; and business customers may rent, lease, or otherwise be allocated one or more virtual machine instances to run one or more proprietary applications. Configuration 100 may therefore facilitate scalable deployment of applications by providing an online service through which a remote image may be booted for a predicted auction winner. Further to the example, therefore, having predicted a likely auction winner, one or more features of configuration 100 may operate to pre-boot a virtual machine instance, which may run the one or more of the aforementioned applications.

Management system 105 may refer to a component or module that may be configured, designed, and/or programmed to manage computing resources (not shown), hosted by or otherwise associated with the datacenter, which may be rented, leased, or otherwise allocated on a temporary basis, via auction. Management system 105 may be implemented as hardware, software, firmware, or any combinations thereof. In that regard, management system 105 may be configured, designed, and/or programmed to interface with one or of auction module 110 and allocation system 115.

Datacenter profiler 106 may refer to a component or module hosted by or otherwise associated with management system 105 that is configured, designed, and/or programmed to manage some or all aspects of speculative allocation of the aforementioned computing resources. For example, datacenter profiler 106 may be configured, designed, and/or programmed to track profiles on usage of each of the aforementioned computing resources. Thus, a tracked profile corresponding to any computing resource may include one or more parameters including, but not limited to: dates, times, and duration of usage for a particular user; and types of applications executed thereon for a particular user.

Auction module 110 may refer to a component or module that may be configured, designed, and/or programmed to implement allocation of resources, which may be attributed to datacenter system configuration 100. Auction module 110 may be implemented as hardware, software, firmware, or any combinations thereof. In that regard, auction module 110 may be configured, designed, and/or programmed to interface with one or of management system 105 and allocation system 115. Auction module 110 may further store data regarding past and current auctions, including, but not limited to, computing resources that are currently available for auction.

Participant profiler 111 may refer to a component or module hosted or otherwise associated with auction module 110 that is configured, designed, and/or programmed to manage some or all aspects of speculative allocation of the aforementioned computing resources. For example, participant profiler 111 may be configured, designed, and/or programmed to track profiles of each past user of the aforementioned computing resources. Thus, a tracked profile corresponding to any user may include one or more parameters including, but not limited to: dates, times, and duration of usage for the user; types of applications executed thereon for the user; bidding history for the user, e.g., opening bids, losing bids, winning bids, number of bids per auction, corporate information, time zone, budgetary information, etc. Alternate embodiments of datacenter system configuration 100 may exclude auction module 110, with participant profiler 111 being incorporated into either of management system 105 or allocation system 115, likely dependent upon an active datacenter business model and policies.

On a more general level, management system 105 and auction module 110, individually or collectively depending on an implemented example embodiment, may perform pre-processing of bidder history data, reducing the data to selected input variables and logical states for use by an algorithm implemented by allocation system 115. The aforementioned pre-processing may include a combination of data mining and business intelligence regarding a respective user's business and/or computing practices.

Allocation system 115 may refer to a component or module that may be configured, designed, and/or programmed to preprocess data pertaining to computing resources that are currently available via auction as well as data pertaining to likely participants for such an auction, in an effort to increase resource efficiency for a predicted auction winner, and to increase revenue for a provider of the computing resources.

Profiling module 116 may refer to a component or module that may be configured, designed, and/or programmed to compile the profiles on usage of each of the currently available computing resources, as tracked by datacenter profiler 106, and the profiles of each past user of the currently available computing resources, as tracked by participant profiler 111.

Alternative embodiments may contemplate profiling module 116 being configured, designed, and/or programmed to track the profiles on usage of each of the currently available computing resources, instead of datacenter profiler 106, and/or to track the profiles of each past user of the currently available computing resources, instead of participant profiler 111.

Predicting and ranking module 117 may refer to a component or module that may be configured, designed, and/or programmed to predict expected outcomes of current auctions for currently available computing resources. That is, in that regard, predicting and ranking module 117 may configured, designed, and/or programmed to predict who will submit winning bids, i.e., winning bidder, in an active auction for one or more of the currently available computing resources from among those for whom a usage profile has been developed and tracked.

Regardless of how the profiles of the currently available computing resources and past users thereof may be compiled, predicting and ranking module 117 may be further configured, designed, and/or programmed to execute various analyses of data included in the profiles. For example, the various analyses may include pivots of the profiles of the available computing resources relative to the profiles of the past auction participants to determine, e.g., trends regarding timing and amounts of bids for computing resources, such as: trends regarding times of years, times of months, times of weeks in which a user bids for available computing resources; trends regarding how many times a particular user bids on an available computing resource; trends regarding how much money a particular user bids on an computing resource; trends regarding how busy a user's other computing resources are; etc.

The various analyses may further include pivots of the profiles of the available computing resources relative to the profiles of the past auction participants to determine, e.g., trends regarding usage of computing resources once won at auction, such as: trends regarding duration of application execution thereon; trends regarding processing requirements for execution of an application for a particular user; trends regarding peak performance demands; trends regarding minimal performance demands; etc. The various analyses may further include machine learning, statistical, or other techniques to generate predictions directed towards anticipating auction winners.

Predicting and ranking module 117 may further compare the results of the various analyses to current auction conditions, including, but not limited to time of the auction (year, month, day, and/or hour) and/or even parameters of available computing resources, e.g., time of availability, associated computing parameters, etc. Accordingly, predicting and ranking module 117 may be able to calculate mathematical probabilities identifying who is likely to bid for any of the available computing resources, how much they might bid, and who is likely to win a current auction. That is, predicting and ranking module 117 may determine, for each user participating in an active auction for computing resources of particular parameters, e.g., a percentage probability that a particular user participates in an active auction; how much money the particular user may bid as an opening bid in the active auction; how many bids the particular user may bid in the active auction; how much money the particular user may ultimately bid in the active auction; etc.; to ultimately predict users, from among those for whom a usage profile has been developed and tracked, who are likely to bid on currently available computing resources.

In accordance with varying embodiments, predicting and ranking module 117 may be further configured, designed, and/or programmed to rank the predicted outcomes of current auctions for computing resources. Methodologies for ranking may vary. For example, ranking based on a probability of final auction purchase price may result in an ordered list of likely auction participants, for whom one or more computing resources may be speculatively allocated. As described herein, speculative allocation of one or more computing resources may include delivery of stored instance contents. Speculative allocation of one or more computing resources may also include booting prior to completion of a corresponding active auction. Alternatively, ranking may be based on a scoring metric that encompasses probability of a particular user auction participant, winning a corresponding auction and confidence in the prediction. Further, ranking module 118 may implement sub-ranking based on confidence within quartiles, which may allow budgeting of speculative computing resource instances in view of imprecise estimates.

Combined metrics for the various embodiments of ranking may be computed with regard to economic costs and benefits weighted by estimates of prediction probability resulting in a ranking that may be based on a best expected profit value for a provider of the computing resources. For example, as a ratio of computing resources, e.g., total virtual machines in a respective datacenter, with regard to those currently available in an active auction increases, the service provider of the computing resources is afforded increasing flexibility to speculatively allocate increasing numbers of, e.g., virtual machine instances. That is, further to the example, booting of at least some of the available virtual machine instances may commence prior to completion of a corresponding active auction.

In accordance with one example methodology, a ranking may be based on a bidding history for each auction participant, resulting in a prediction of a single most likely winning bid for each auction participant, thus maximizing the number of potential winning bidders, relative to the number of available computing resources. Thus, the resulting ranking may attempt to capture, at least, the most likely predicted scenario for the greatest number of winners for an active auction.

In accordance with another example methodology, a ranking may be based on a bidding history for a particular auction participant, resulting in a prediction that the particular auction participant may submit winning bids for a certain number of currently available computing resources. Thus, the resulting ranking may attempt to fulfill, at least, the most likely predicted scenario for the greatest number of winners in an active auction.

Thus, predicting and ranking module 117 may generate a classifier based on historical behavior to generate a metric reflecting likelihood of winning an auction using machine learning, such as support vector machines or multicomponent classifiers. Then situation data and customer data may be entered for each user, and resulting scores may be used to rank the auction participants. Further, predicting and ranking module 117 may be configured, programmed, and/or designed to generate sequential predictions as increasing amounts and types of data become available. As an example, after making a first prediction regarding opening bids, predicting and ranking module 117 may then utilize real opening bids as part of the inputs for making further prediction as to who will win.

Speculative allocation module 118 may refer to a component or module that may be configured, designed, and/or programmed to order or otherwise implement the delivery and/or pre-start, e.g., boot-up, of computing resources in accordance with the ranked predictions generated by predicting and ranking module 117. Speculative allocation module 118 may order or otherwise implement the pre-start of currently available computing resources that are selected based on ranked predictions that meet or exceed a threshold level, which may be predetermined by any one or more datacenter management systems or components.

Speculative allocation module 118 may be further configured, designed, and/or programmed to freeze the pre-started computing resources for which pre-starting, e.g., booting, has been completed prior to completion of an active auction thereof. Accordingly, a pre-started computing resource may be ready for a winning auction participant to be granted immediate access. Thus, the winning auction participant does not have to wait for pre-start time. For the service provider of the computing resources, if there is a sufficient number of computing resources available, the incremental cost of speculative allocation of the respective resources is almost null, thus facilitating a high probability of success with speculative recovery of otherwise wasted resource time.

Speculative allocation module 118 may act or operate independently or in cooperation with hypervisor 120. Alternative embodiments of datacenter system configuration 100 may contemplate speculative allocation module 118 being shared between allocation system 115 and hypervisor 120. Further alternative embodiments may associate speculative allocation module 118 with hypervisor 120, exclusively, as opposed to allocation system 115, particularly since control and/or management of virtual machine instances may be more appropriate for a hypervisor.

Hypervisor 120 may refer to a component or module that is configured, designed, and/or programmed to manage computing resources. Hypervisor 120 may be implemented as hardware, software, firmware, or any combinations thereof. In that regard, hypervisor 120 may be configured, designed, and/or programmed to interface with one or more requests or commands from allocation system 115, particularly speculative allocation module 118, to execute multiple operating systems securely and independently on, at least, currently available computing resources, such as virtual machine instances. For example, hypervisor 120 may be configured to boot-up one or more of the currently available virtual machine instances and, further, freeze operation of a booted-up virtual machine instance that has not yet been allocated to a winning auction participant. Further, in view of interchangeable responsibilities for speculative allocation module 118 and hypervisor 120, they are depicted as overlapping in FIG. 1.

Accordingly, by the above description of datacenter system configuration 100, a pre-starting computing resource may be ready for a winning auction participant to be granted immediate access based on reasoned speculation or predictions.

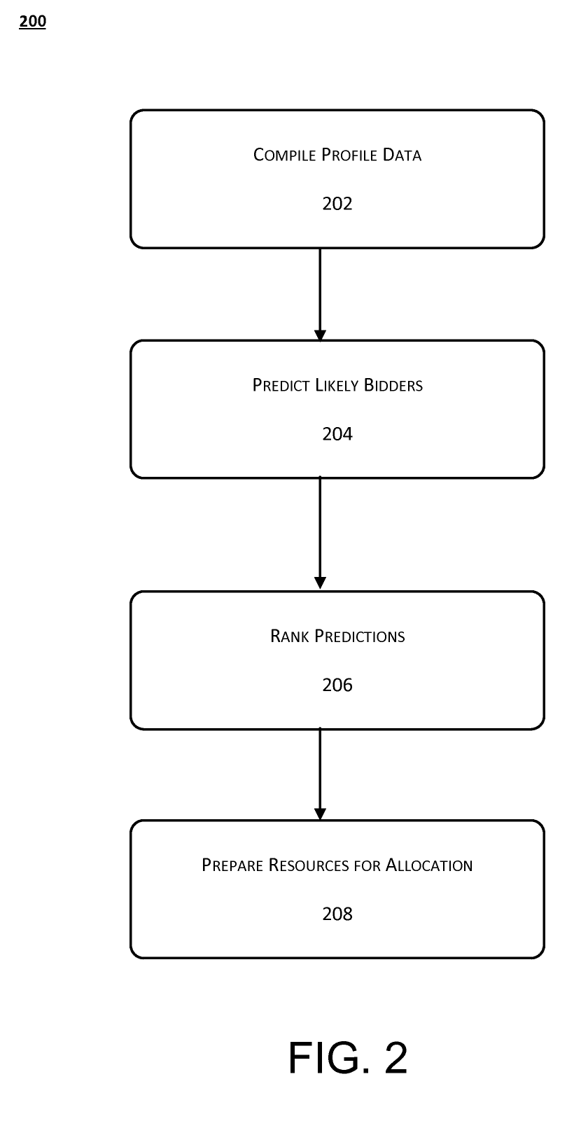

FIG. 2 shows an example processing flow 200 of operations to implement speculative allocation of instances, arranged in accordance with at least some embodiments described herein. Processing flow 200 may be implemented by the depicted embodiment of datacenter system configuration 100 or various permutations thereof. Processing flow 200 may include one or more operations, actions, or functions depicted by one or more blocks 202, 204, 206, and 208. Although illustrated as discrete blocks, various blocks may be divided into additional blocks, combined into fewer blocks, or eliminated, depending on the desired implementation.

Further, as set forth above, datacenter system configuration 100, and therefore processing flow 200 as well, may pertain to a datacenter or cloud services platform, of which one or more computing resources may rented, leased, or otherwise allocated on a non-permanent time- or task-basis. Again, as referenced herein, unless otherwise indicated expressly, by example, or by context, computing resources may be understood to include but not be limited to one or more virtual machine instances, at least portions of field programmable gate arrays (FPGA), compute containers, network resources, software services etc. In the context of datacenter system configuration 100 and processing flow 200, an auction participant may at least submit bids to rent, lease, or otherwise be allocated one or more computing resources in accordance with various business models that include, but are not limited to, auctions. With regard to the auction business model, an auction participant, may be allocated computing resource, e.g., by the minute, hour, day, week, etc., or as a task-based rental.

In the context of processing flow 200, an example method for speculative allocation of datacenter resources may include tracking data, for each of one or more users of computing resources, including a respective history of auction bids and a respective history of computing resource usage; predicting, based on the tracked data, respective probabilities that each of the one or more users will submit a qualifying bid for one or more available computing resources during a current auction; ranking the predictions; and preparing the available computing resources for allocation to at least one of the users in accordance with the ranked predictions. Thus, processing flow 200 may pertain to preparing computing prior to completion of a transaction, e.g., therefore. Processing flow 200 may begin at block 202.

Another example method or set of operations for speculative allocation of datacenter resources may include predicting winning bidders in an auction for computing resources; pre-placing computing resources before the auction has been completed; pre-starting at least a portion of the pre-placed computing resources before the auction has been completed; and assigning pre-started computing resource to one of the predicted winning bidders who has submitted a winning bid. When the available computing resources are virtual machine instances, the example may include pre-placing machine images prior to completion of the auction; booting up at least a portion of the pre-placed machine images; and assigning a booted-up virtual machine to a predicted auction winner.

Referring to processing flow 200, block 202 (Compile Profile Data) may refer to profiling module 116, associated with allocation system 115, compiling profiles on usage of each of the currently available computing resources, as tracked by, e.g., the datacenter profiler 106 of management system 105, and the profiles of each past user of the currently available computing resources, as tracked by, e.g., the participant profiler 111 of auction module 110. Alternatively, block 202 may refer to profiling module 116, alone based on an alternative configuration thereof, tracking the profiles on usage of each of the currently available computing resources. Block 202 may be followed by block 204.

Block 204 (Predict Likely Bidders) may refer to predicting and ranking module 117 predicting expected outcomes of current auctions for currently available computing resources. For example, predicting and ranking module 117 may analyze bidding and usage trends for each past user of the currently available computing resources to calculate mathematical values indicative of, e.g., a percentage probability that a particular user will participate in an active auction; how much money the particular user may bid as an opening bid in the active auction; how many bids the particular user may bid in the active auction; how much money the particular user may ultimately bid in the active auction; etc.; to ultimately predict users, from among those for whom a usage profile has been developed and tracked, who are likely to bid on currently available virtual machine instances and, likely, win the active auctions. The aforementioned example predictions may be generated and/or utilized separately or in various combinations thereof. However, predicting and ranking module 117 may be configured, programmed, and/or designed to generate sequential predictions as increasing amounts and types of data become available. For example, after making a first prediction regarding opening bids, predicting and ranking module 117 may then utilize real opening bids as part of the inputs for making further prediction as to who will win. Block 204 may be followed by block 206.

Block 206 (Rank Predictions) may refer to predicting and ranking module 117 further ranking the predicted outcomes of current auctions for currently available computing resources. As described previously, combined metrics for the various embodiments of ranking may be computed with regard to economic costs and benefits weighted by estimates of prediction probability resulting in a ranking that may be based on a best expected profit value for a provider of the computing resources. Accordingly, a ranking may be based on a bidding history for each auction participant, resulting in a prediction of a single most likely winning bid for each auction participant, thus maximizing the number of potential winning bidders, relative to the number of available computing resources. Thus, the resulting ranking may attempt to capture, at least, the most likely predicted scenario for the greatest number of winners for an active auction. Alternatively, a ranking may be based on a bidding history for a particular auction participant, resulting in a prediction that the particular auction participant may submit winning bids for a certain number of currently available computing resources. Thus, the resulting ranking may attempt to fulfill, at least, the most likely predicted scenario for the greatest number of winners in an active auction. Block 206 may be followed by block 208.

Block 208 (Prepare Resources for Allocation) may refer to speculative allocation module 118 and/or hypervisor module 120 pre-starting one or more currently available computing resources in accordance with the ranked predictions generated at block 206. Speculative allocation module 118 may order or otherwise implement the pre-start of one or more currently available computing resources that are selected based on ranked predictions that meet or exceed a threshold level.

Block 208 may further refer to speculative allocation module 118 and/or hypervisor module 120 freezing the pre-started computing resources prior to completion of an active auction thereof. As an example, when one or more virtual machine instances are booted prior to completion of an active auction thereof, block 208 may refer to them being suspended or frozen until the active auction thereof is completed.

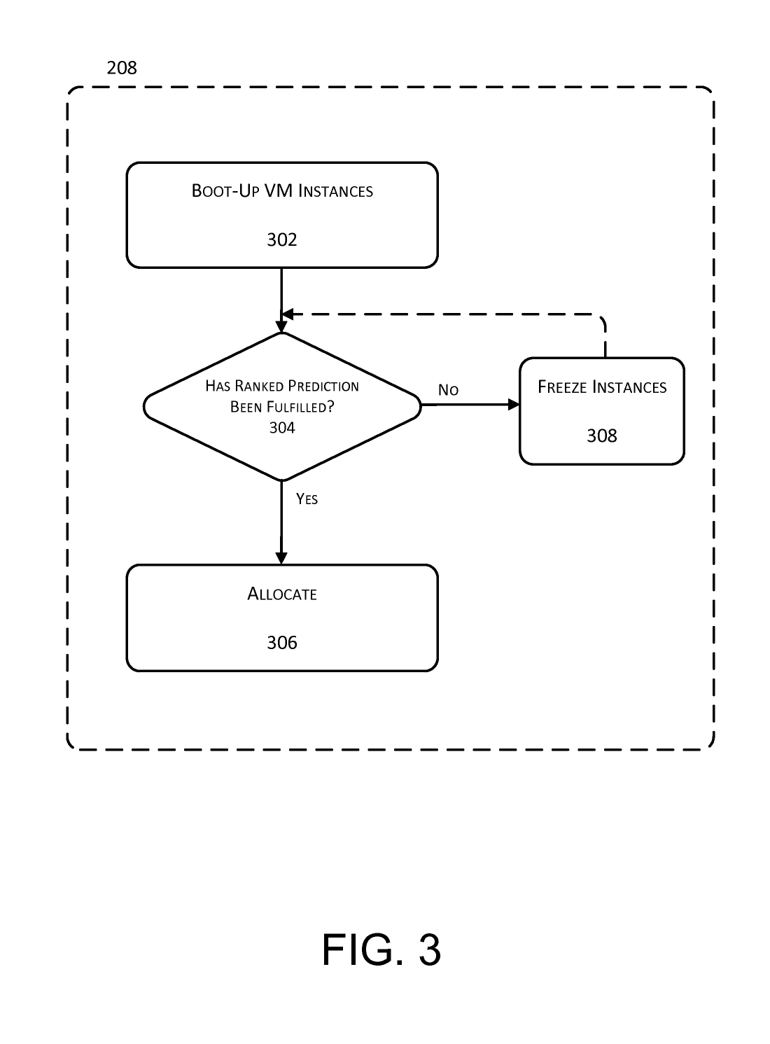

FIG. 3 shows an example processing flow of operations to implement resource preparation for allocation, arranged in accordance with at least some embodiments described herein. More particularly, FIG. 3 shows example operations corresponding to block 208 (Prepare Resources for Allocation) that may include one or more sub-operations, actions, or sub-functions depicted by one or more blocks 302, 304, 306, and 308. Although illustrated as discrete blocks, various blocks may be divided into additional blocks, combined into fewer blocks, or eliminated, depending on the desired implementation.

Block 302 (Boot-Up VM Instances) may refer to speculative allocation module 118 and/or hypervisor module 120 pre-starting available computing resources that have been pre-placed among the datacenter based on the active auctions and the ranked predicted outcomes therefore. Block 302 may be followed by decision block 304.

Decision block 304 (Has Ranked Prediction Been Fulfilled?) may refer to speculative allocation module 118 and/or hypervisor module 120 determining whether ranked prediction has been fulfilled. Speculative allocation module 118 and/or hypervisor module 110 may receive a status regarding an active auction from one or more sources that may include, but not be limited to, auction module 110. If ranked prediction has been fulfilled, as indicated in the status received by speculative allocation module 118 and/or hypervisor module 110, decision block 304 may be followed by block 306. Otherwise, decision block 304 may be followed by block 308.

Block 306 (Allocate) may refer to speculative allocation module 118 and/or hypervisor 120 granting immediate access of a pre-started computing resource to a winning auction participant, upon the positive determination at decision block 304.

Block 308 (Freeze Instances) may refer to speculative allocation module 118 and/or hypervisor 120 waiting for, or once again requesting, a status regarding an active auction from the aforementioned one or more sources and, therefore, maintaining the one or more available computing resources in a frozen state. Accordingly, with the one or more available computing resources in a frozen status, processing may revert back to decision block 304, indicative of speculative allocation module 118 and/or hypervisor module 120 determining whether ranked prediction has been fulfilled.

Thus, as a result of implementation of processing flow 200, including the sub-processes for block 208, a pre-started computing resource may be ready for a winning auction participant to be granted immediate access and, therefore, the winning auction participant does not have to pay for pre-start time.

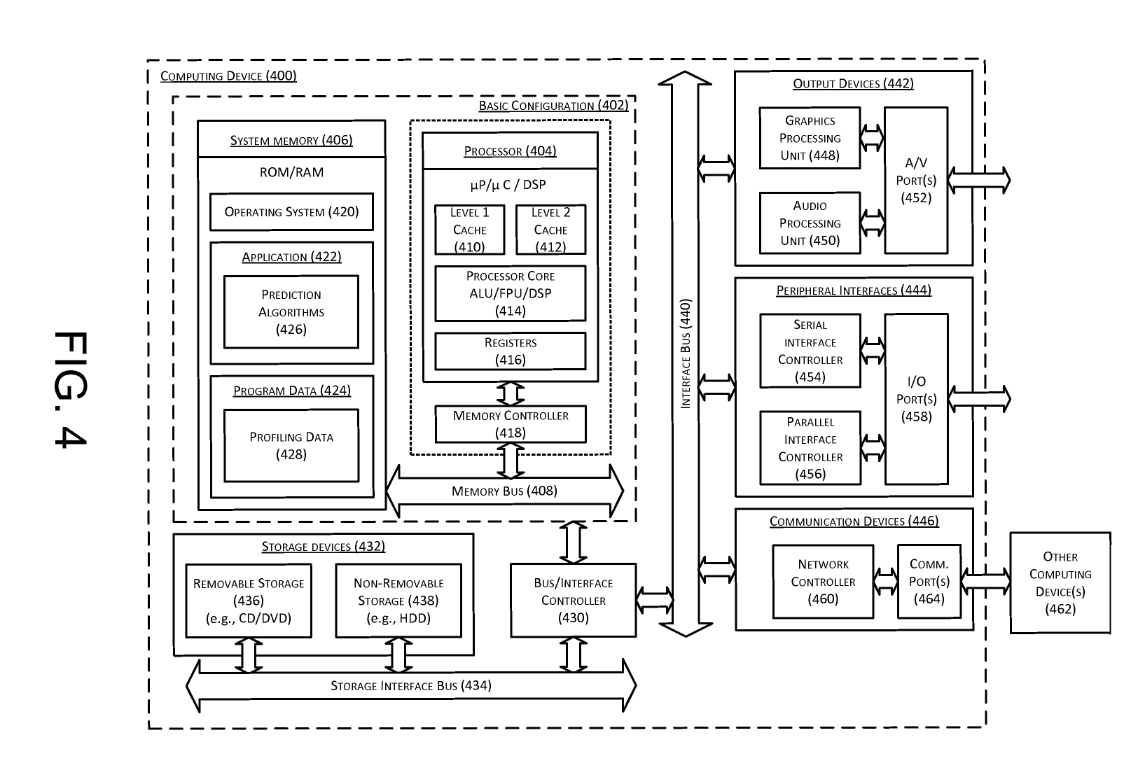

FIG. 4 shows a block diagram illustrating an example computing device by which various example solutions described herein may be implemented, arranged in accordance with at least some embodiments described herein.

In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include one or more prediction algorithms 426 that may be arranged to perform the functions as described herein including those described with respect to processing flow 200 of FIG. 2 and sub-processing of block 208 in FIG. 3. Program data 424 may include profiling data 428 that may be useful for operation with the various prediction algorithms 426 as described herein. Profiling data 428 may include profile data for any available datacenter resources, e.g., virtual machine instances, and profile data regarding any past user of currently available datacenter resources. In some embodiments, application 422 may be arranged to operate with program data 424 on operating system 420 such that implementations of speculative allocation of instances may be provided as described herein. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 544 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a server or a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for system configuration 100 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium, e.g., a fiber optic cable, a waveguide, a wired communications link, a wireless communication link, etc.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A method for speculative allocation of computing resources, comprising:
tracking data, for each of one or more users of computing resources, including a respective history of auction bids and a respective history of computing resource usage;
predicting, based on the tracked data, respective probabilities that each of the one or more users will submit a qualifying bid for one or more available computing resources during a current auction;
ranking the predictions; and
preparing the available datacenter resources for allocation to at least one of the users in accordance with the ranked predictions.

2. The method of claim 1, wherein the tracked data, for each of the one or more users, includes user profile information, a history of winning auction bids, a history of losing auction bids, and bid patterns.

3. The method of claim 1, wherein the profile information for each of the one or more users includes an industry or service, a history of peak needs.

4. The method of claim 1, wherein the predicting is further based on deployment data regarding the available computing resources.

5. The method of claim 1, wherein the predicting is further based on pricing of the available computing resources.

6. The method of claim 1, wherein the preparing includes pre-positioning multiple virtual machine instances across the datacenter.

7. The method of claim 6, wherein the preparing includes booting at least a portion of the pre-positioned multiple virtual machine instances.

8. The method of claim 7, wherein the preparing further includes freezing at least one of the booted virtual machine instances if a winner in the current auction for the at least one booted virtual machine instance has not yet been determined.

9. The method of claim 7, wherein the preparing further includes shutting down at least one booted virtual machine resource that is not awarded in the current auction.

10. The method of claim 1, further comprising:
awarding a booted up datacenter resource to at least one user who has submitted a qualifying bid; and
billing the at least one user for time used to boot up the awarded datacenter resource.

11. A system for speculative allocation of computing resources, comprising:
a management module configured to store prediction variables;
a prediction module configured to predict, based on at least the prediction variables, respective probabilities that one or more users will submit a qualifying bid for one or more available computing resources during a current auction;
a hypervisor configured to prepare the available computing resources for allocation upon completion of the current auction.

12. The system of claim 11, wherein the prediction variables include user profile information, a history of winning auction bids, a history of losing auction bids, and bid patterns.

13. The system of claim 11, wherein the prediction module is configured to, at least, comparatively match one or more of the prediction variables to features of the available computing resources.

14. The system of claim 13, wherein the features of the available computing resources include statistics regarding at least one of pricing and performance.

15. The system of claim 11, wherein the hypervisor is configured to prepare one or more of the available computing resources by pre-positioning one or more virtual machine instances across the datacenter.

16. The system of claim 11, wherein the hypervisor is configured to prepare one or more of the available computing resources by booting at least a portion of the pre-positioned multiple virtual machine instances.

17. The system of claim 16, wherein the hypervisor is configured to prepare one or more of the available computing resources by freezing at least one of the booted virtual machine instances if a winner in the current auction for the at least one booted virtual machine instance has not yet been determined.

18. The system of claim 16, wherein the hypervisor is configured to prepare one or more of the available computing resources by shutting down at least one booted virtual machine resource that is not awarded in the current auction.

19. The system of claim 11, further comprising:
a manager configured to account for time required to boot up an awarded one of the available computing resources.

20. A non-transitory computer-readable medium storing instructions that, when executed, cause one or more processors to perform operations comprising:
predicting winning bidders in an auction for computing resources;
pre-placing machine images before the auction has been completed;
booting-up at least a portion of the pre-placed machine images before the auction has been completed; and
assigning a booted-up virtual machine to one of the predicted winning bidders who has submitted a winning bid.

21. The non-transitory computer-readable medium of claim 20, wherein the operations further comprise:
charging for time needed to boot-up one of the assigned virtual machines.
